(19) United States
(12) Patent Application Publication
(10) Pub. No.: US 2012/0182745 A1
(43) Pub. Date: Jul. 19, 2012

(54) Electroluminescent Panels Adaptable For Electronic Devices

(76) Inventors: Michael E. Ogrinz, Easton, CT (US); Mark H. Mathias, Westport, CT (US)

(21) Appl. No.: 12/896,835

(22) Filed: Oct. 1, 2010

Related U.S. Application Data
(60) Provisional application No. 61/247,805, filed on Oct. 1, 2009.

(51) Int. Cl. F21V 21/00

(52) U.S. Cl. 362/382

(57) ABSTRACT

An electroluminescent (EL) display kit is designed to removably attach to a host device, such as the outside top cover of a conventional laptop computer or the back of a cell phone, texting device, or handheld electronic pad. The EL display draws its electrical power from the host device through an adapter cable. In the laptop kit, the EL display is powered and controlled by a USB cable which secretes into one of the USB ports of the laptop computer. The EL display conveys a variety of both static and dynamic visual information to a viewer. In a second embodiment the EL display is integrated into the laptop computer during the OEM manufacturing process. In a third embodiment a consumer may design, manufacture, and assemble his own artwork in the EL display which is then attached to a laptop computer or another host electronic device.

### CROSS REFERENCES TO RELATED APPLICATIONS

This non-provisional patent application claims a priority benefit to U.S. Provisional Application No. 61,247,805 entitled “Electroluminescent Panels for Laptop Computers” filed in the United States Patent and Trademark Office on Oct. 1, 2009 by common Inventors to this instant application, Michael E. Ogrinz and Mark H. Mathias. Further the above named entire Provisional Application is hereby incorporated by reference.

### STATEMENT REGARDING FEDERALLY SPONSORED RESEARCH

Not Applicable

### REFERENCE TO APPENDIX

Not Applicable

### FIELD OF THE INVENTION

This invention relates to devices for displaying creative designs and or information through illuminating devices.

### BRIEF SUMMARY OF THE INVENTION

In a first embodiment, the invention is an electroluminescent (EL) display that is designed to easily attach to the outside panel of the display of a laptop computer and further be powered by a cable which can be plugged into the laptop's external USB port.

### BACKGROUND OF THE INVENTION

Electroluminesce (EL) was first observed in 1907 by Captain Henry Joseph Round in silicon carbide (SiC), although electroluminescent display technology was not made commercially available until the 1960s.

Electroluminescence is the result of a radiative recombination of electrons and holes in a material (usually a semiconductor). The excited electrons release their energy as photons. Prior to recombination, electrons and holes are separated either as a result of doping of the material to form a p-n junction (in semiconductor electroluminescent devices such as LEDs), or through excitation by impact of high-energy electrons accelerated by a strong electric field (as with the phosphors in electroluminescent displays).

The most common EL devices are either powder (primarily used in lighting applications) or thin film (for information displays.)

Powder phosphor-based electroluminescent panels are frequently used as backlights to liquid crystal displays. They readily provide a gentle, even illumination to the entire display while consuming relatively little electric power. This makes them convenient for battery-operated devices such as pagers, wristwatches, and computer-controlled thermostats and their gentle green-cyan glow is a common sight in the technological world. They do, however, require relatively high voltage. For battery-operated devices, this voltage must be generated by a converter circuit within the device. For line-voltage operated devices, it may be supplied directly from the power line. Electroluminescent nightlights operate in this fashion.

Recently, blue, red, and green emitting thin film electroluminescent materials have been developed that offer the potential for long life and full color electroluminescent displays.

In either case, the EL material must be enclosed between two electrodes and at least one electrode must be transparent to allow the escape of the produced light. Glass coated with indium oxide or tin oxide is commonly used as the front (transparent) electrode while the back electrode is coated with reflective metal. Additionally, other transparent conducting materials, such as carbon nanotube coatings or PEDOT can be used as the front electrode.

The display applications are primarily “passive” (i.e. voltages are driven from edge of the display.) Similar to LCD trends, there have also been Active Matrix EL (AMEL) displays demonstrated, where circuitry is added to prolong voltages at each pixel.

Electroluminescent technologies have low power consumption compared to competing lighting technologies, such as neon or fluorescent lamps. This, together with the thinness of the material, has made EL technology valuable to the advertising industry. Relevant advertising applications include electroluminescent billboards and signs. EL manufacturers are able to control precisely which areas of an electroluminescent sheet illuminate, and when. This has given advertisers the ability to create more dynamic advertising which is still compatible with traditional advertising spaces.

In principle, EL lamps can be made in any color. However, the commonly-used greenish color closely matches the peak sensitivity of human vision, producing the greatest apparent light output for the least electrical power input. Unlike neon and fluorescent lamps, EL lamps are not negative resistance devices so no extra circuitry is needed to regulate the amount of current flowing through them.

Thus there is a need for an electroluminescent display device that is easily adaptable to a personal laptop computer or other electronic devices such as cell phones, pagers, walkie-talkies, mp3 players, touch pads, electronic book readers, and handheld data entry devices. The EL display has many benefits such as personalizing and identifying one laptop or electronic device from another. This alone has security and anti-theft benefits. The EL display can further be programmed or controlled so as to provide information in various formats. Corporations, small businesses and other entrepreneurs can use these devices to promote their branding or convey advertising messages.

Such a device or convenience is heretofore unknown to the inventor. In general this apparatus has the potential for entertaining and improving the quality of life for school children, college students, professionals, and senior citizens. It expands the usefulness and communication potential of one's laptop computer and or other electronic device.

### OBJECTS AND ADVANTAGES

The primary purpose of this invention is to personalize one's own computer laptop, cell phone or other electronic device with an aesthetic illuminated visual design in a first embodiment and in further embodiments provide informational features as well.

Accordingly, several objects and advantages of my invention are:

(a) to provide a feature for computer laptops or other electronic devices whereby such feature is easily adapted to any personal computer or other electronic devices;

(b) to provide a laptop or other electronic device feature that makes use of electroluminescent display technology;

(c) to provide an electroluminescent display that can be electrically powered from a laptop computer or other electronic device without overburdening the laptop computer or other electronic devices;

(d) to provide an electroluminescent display that can be easily affixed to a laptop computer or other electronic devices;

(e) to provide an electroluminescent display kit for corporations, small businesses and advertisers conveying branding or marketing information and easily adapted to a user/consumer's laptop computer or other electronic devices; and

(f) to provide an electroluminescent display kit for a consumer that can be easily personalized for and adapted to his laptop computer or other electronic devices.

Further objects and advantages of my invention will become apparent from a consideration of the drawings and ensuing description.

### BRIEF DESCRIPTION OF THE DRAWINGS

FIG. 1 is a side perspective exploded general view of a first embodiment of the invention;

FIG. 2 is a side perspective exploded detailed view of a second embodiment of the invention;

FIG. 3 is a side perspective exploded detailed view of a third embodiment of the invention;

FIG. 4 is a top plan view of an EL multi-segmented static information display;

FIG. 5 is a top plan view of an EL multi-segmented variable information display;

FIG. 6 is a schematic diagram of a circuit for selectively driving a multi-segment EL display; and

FIG. 7 is a side perspective exploded detailed view of a fourth embodiment of the invention.

### DETAILED DESCRIPTION OF THE EMBODIMENTS

‘VidLids’ is an accessory device that can be used to display an illuminated visual design, text, messaging and or other information. The accessory device can be stand-alone, but a preferred embodiment is as a feature that can be attached or integrally assembled with a host device such as a laptop computer or other usually portable electronic device. It displays two primary types of information: static and variable. Static information may still show visual motion and activity, but the information content displayed does not change. Variable information is controlled by a device and would allow letters, numbers, special characters, images, and more to be displayed under the control of a device.

One of the preferred embodiments of VidLids is to augment the display panel of a personal laptop computer. However, this particular embodiment does not limit or prevent further adaptations, extensions and uses.

Basic Design

The basic design of a Vid Lids apparatus is that of an EL display panel in communication with a controller by wired or wireless means. Data and control signals may be transmitted wirelessly through many known technologies such as Bluetooth. Power may be supplied by conventional wire means or wirelessly through induction as well.

The first embodiment of Vid Lids uses electroluminescent (EL) material as the display medium powered by a ribbon cable with a power supply/controller device that causes the display to illuminate in a desired pattern or manner. Other materials besides EL could be used for the display and the power supply/controller device may be the same or may be separate and may control the display via wires or wirelessly.

The first embodiment is designed so that a back surface of the EL display will adhere to the top (outside lid) of a laptop computer with non-permanent, non-marking adhesive, hook and loop fastener, or other form. Alternatively, in the instance where VidLids is part of the original equipment from a manufacturer, all of these items would be a permanent part of the computer rather than an add-on accessory.

In the case of a wired controller, the portion of the lid that illuminates would be connected to the power supply/controller device by a cable (ribbon, round, or other) that would run under an outer skin material that is used to adhere the entire device to the laptop cover.

Two Modes

There are two general modes of operation for VidLids.

Static Information

A static information display is when a VidLid display or the illumination or other activation of part(s) of the EL display are controllable, but the information that is displayable is not. For example, a segment on the VidLid may be either on or off, could blink, could be part of a sequence of lights, or similar. What would not change are things such as words or numbers. In the case of static information, it is typical, but not required, that the images that can turn on and off are visible with the naked eye in either state, i.e., on or off.

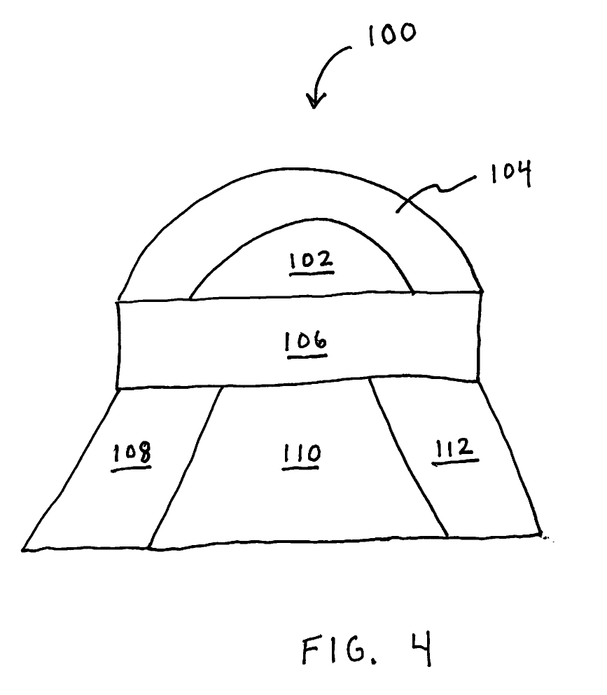

Referring now to FIG. 4, a static information electroluminescent display 100 is shown. Each of the EL display segments 102, 104, 106, 108, 110, 112 is under separate electrical control. Also each of the display segments 102, 104, 106, 108, 110, 112 may any color available in the EL display market. As each segment 102, 104, 106, 108, 110, 112 is illuminated or darkened, the information does not change, and thus is static. Although we have characterized this as ‘Static Information display’, we know that in certain embodiments covert, coded, semaphore, and or visual message signaling may occur on a display of this nature by changing the display in a predetermined sequence, but while possible it is a secondary embodiment.

Variable Information

A Variable information display is when a VidLid that allows users to cause display items such as text or images (still or moving) on the lid. For example, if the text “Hello world.” is to be displayed, the text will be supplied by the controller device rather than being a fixed part of the display.

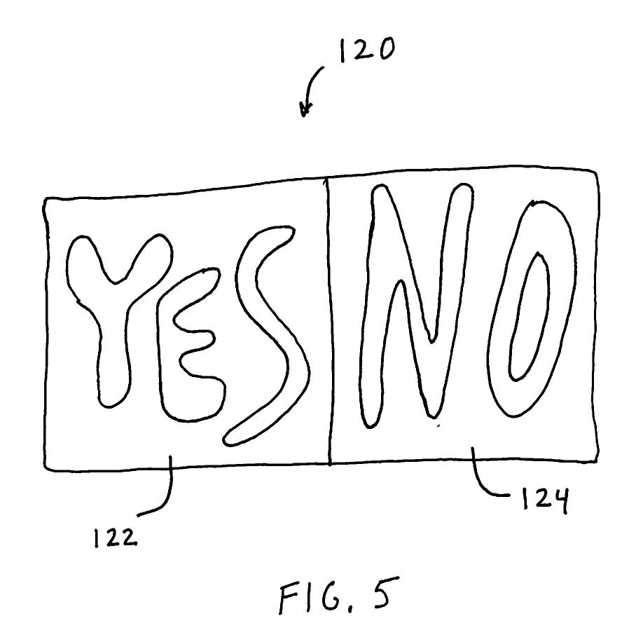

Now referring to FIG. 5, a variable information electroluminescent display 120 is shown. This particular display 120 is divided into two halves, the ‘YES’ half 122 and the ‘NO’ half 124. Each half of the display may be illuminated separately in time so that different information is conveyed to a viewer. Other informational displays may be designed in a similar manner.

Other variable information could be stock prices, a sports score, local temperature, local altitude, a PowerPoint screen number of the slideshow being shown on the laptop display, a word or words, etc. Typically these would be provided through a controller and either software or some other method of communicating with the display.

Other Variations

In the first embodiment, VidLids is affixed to or integrated into the outside surface of the top lid or shell of a laptop computer. However, the VidLid display could be removable and separate from the laptop as a stand-alone device.

VidLid Embodiments

VidLids can come in a wide variety of product embodiments including but not limited to the following:

Still artwork (illuminated, with or without reveals). This artwork is easily configured to be unique and or mass produced.

Motion artwork (simulating the appearance of rotating, turning, sequencing, oscillating, etc.). Different EL segments can be electrically sequenced (varying times of illumination and varying sequences relative to other EL segments) so as to give the appearance of motion or animation.

Licensed logo artwork (e.g. Bank of America, Microsoft, Pfizer, NFL, Harry Potter, etc.) We shall seek license agreements to allow the manufacture and sale of highly and well known trademark logos. The logos or trademarks will be displayed in colors faithful to the trademarks. The logos can also be animated or illuminated in flashing or other illumination sequences.

Industrial uses: VU meters, Personal status (Open for business, do not disturb, Happy!, etc.), weather (current and forecast), etc. Further certain laptops may be integrated with sensors such as a smoke detectors, temperature sensors, motion detectors, chemical detectors, and an alarm condition can be displayed by the VidLid.

Personal uses: Certain computer notifications such as ‘you have mail’, alarm clocks, search results, stock price, and other informational notifications can be displayed by the VidLid.

Personalizing your VidLid. A further embodiment would be a basic illumination VidLid kit with the ability for a user to create their own overlay, such as printing a design on a transmissive media.

More examples: A panel that provides 3 sections. A user covers the segments with the phrases, “Cloudy”, “Sunny”, or “Rain”. The user then interacts with a custom software application executing on a device to retrieve the local weather forecast and light the appropriate section.

Alternatively a Software Development Kit (SDK) will be offered for developers or more sophisticated users who want to write and create their own application/interface to possibly retrieve information from the Internet and drive the EL displays accordingly.

An EL panel that contains multiple sections, for example a 10 section panel. The user covers them with a bar-chart diagram and creates a custom CPU-usage monitoring application. With each 10% increase in CPU activity, the user directs the panel to light a successive section, thus creating a CPU load monitor and display.

### DESCRIPTION OF THE FIGURES

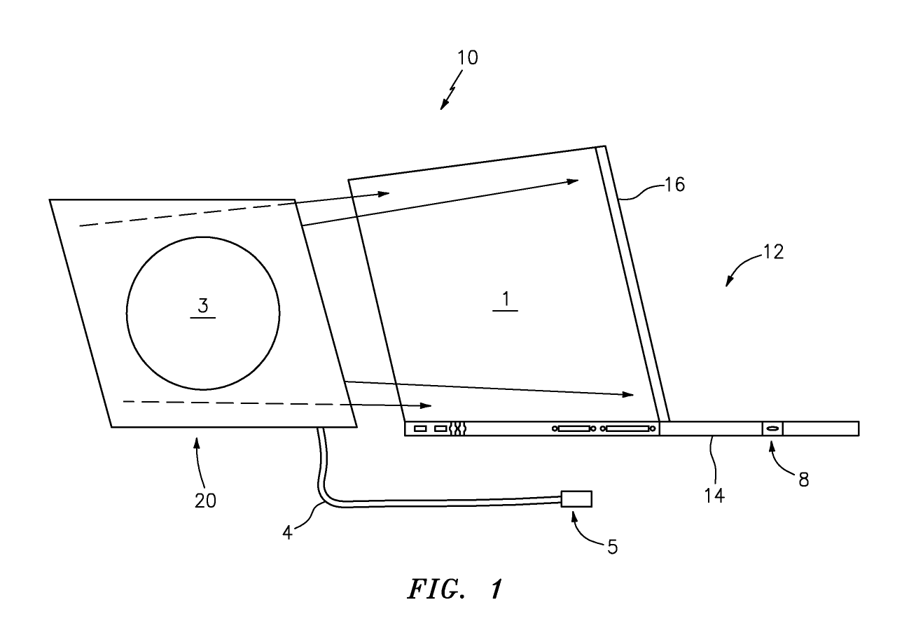

Now referring to FIG. 1, a general diagram of the display invention 10 is shown. A laptop computer 12 having a keyboard base 14 and a hinged top cover 16 is shown in the normal open configuration. An electro-luminescent assembly 20 is positioned just before being attached to the outside surface 1 of the top cover 16. The assembly 20 will be attached to the outside surface 1 of the top cover 16 by an adhesive or glue suitable for the materials involved. For example, some laptop shells are made of plastic whereas other shells are made of aluminum. The assembly 20 has an EL display or messaging area 3 which can be of any shape or size that will fit on the assembly 20. The display 3 is powered and controlled through a cable 4 having a connector 5 that plugs into a USB port 8 on the laptop computer. The cable 4 is preferably very thin and flat for adhesive mating along the laptop outer case to the USB port 8. A proprietary software program running on the laptop 12 senses the connector 5 as it mates into the USB port 8 and runs a predetermined program which controls the display 3 lighting and sequencing. A control panel (not shown) may popup on the laptop main display for user interaction with respect to settings, messaging or other controls for the EL display 3. The laptop software program may be in communication/control with a supervisor control program running on a remote server over the Internet or other networking system.

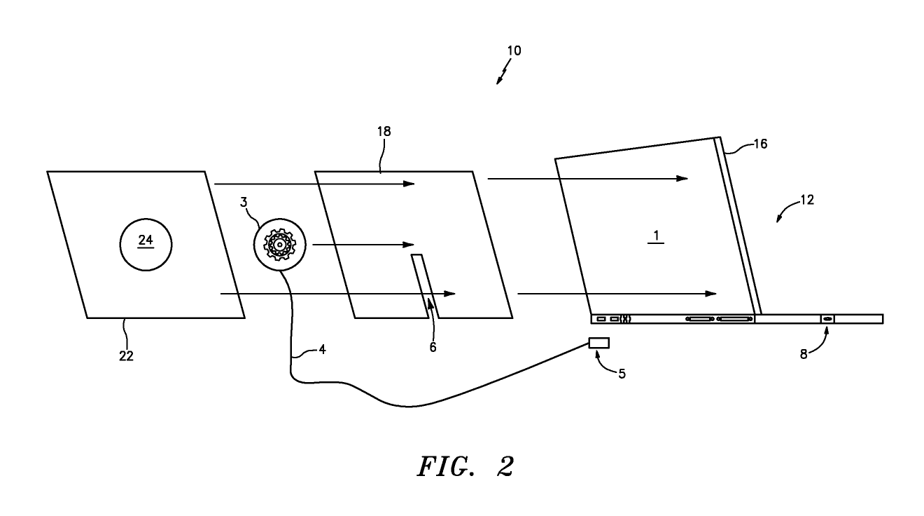

Now referring to FIG. 2, a second embodiment of the invention 10 is shown. In this figure the components of the electro-luminescent assembly 20 are shown in an exploded view. An inner skin 18 having a cable slot 6 is first attached to the outside surface 1 of the top cover 16. The inner skin 18 provides a mounting surface for the electroluminescent display 3. Once the EL display 3 is mounted on the inner skin 18, the power/communication cable 4 is routed in the cable slot 6 and the connector 5 is plugged into a USB port 8 on the laptop computer 12. Lastly the outer skin 22 is mounted onto the inner skin 18 so that the circular cutout 24 aligns with the electroluminescent display 3. It should be noted that the power/communication cable 4 may provide both electrical power and control signals to the electroluminescent display 3. Such control signals are generated by a software program executing on the laptop's CPU (not shown) and drive the data signals on the USB port 8. These data signals may be generated in a predetermined sequence or they may also be generated in a completely random manner. The consumer may select one or more different visual sequences from list of basic options. Such selections may be combined into a ‘playlist’ so that a consumer can configure the Vidlids device for different moods or occasions. The consumer may also create his own custom pattern of illumination.

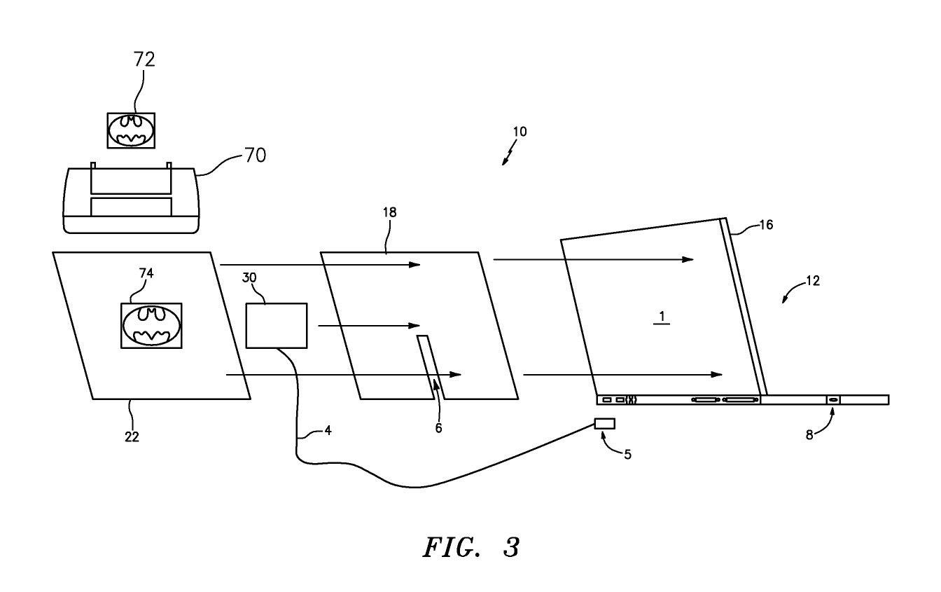

Now referring to FIG. 3, a user customizable embodiment of the invention 10 is shown. In this embodiment a user first generates artwork 74 on a computer and prints the artwork 74 on a special light transmissive paper 72. The user then peels off the artwork 74 and attaches it directly to either the outer skin 22 or a white light illuminating EL panel 30. The white light EL panel 30 may be either constantly lit, varying levels of illumination, or a panel with animation. This unit is then assembled in the same manner as in FIG. 2. Thus in this embodiment a user is able to generate any artwork he desires and incorporated into a VidLid display. Some examples of the kind of artwork a user may make are:

Making a custom light-up portrait;

Adding a custom phrase; and

Adding a custom design.

It should be noted that the arrows in FIGS. 1-3 show the direction of assembly of the parts.

Laptop USB Power

Power is supplied over a standard Universal Serial Bus (USB) Series ‘A’ connector at 5 VDC @ 100 mA on pins 1 and 4; pin 1 being positive, pin 4 being ground. If there is no use of the other pins on the USB port 8, then there can be a pass-through connector to allow other devices to connect to this same port to exchange data with the computer. This can be implemented using a ‘Y’ USB cable.

In general the circuit consists of a small oscillator driving a small step-up transformer. The output of that is routed through six high voltage Silicon Controlled Rectifier (SCR) from Unisonic Technologies Co., Ltd, (PCR 406, 300/400V_{DRM}), or similar devices.

The six SCRs form six outputs supplying approximately a few hundred volts at very low current.

Under one possible implementation, a small surface mount IC sequences the six SCRs, thus driving the six outputs one at a time in a predefined pattern.

Under another implementation, an IC instead receives data sent over the USB connector (in addition to simply power) and lights various portions of the EL display based on this information.

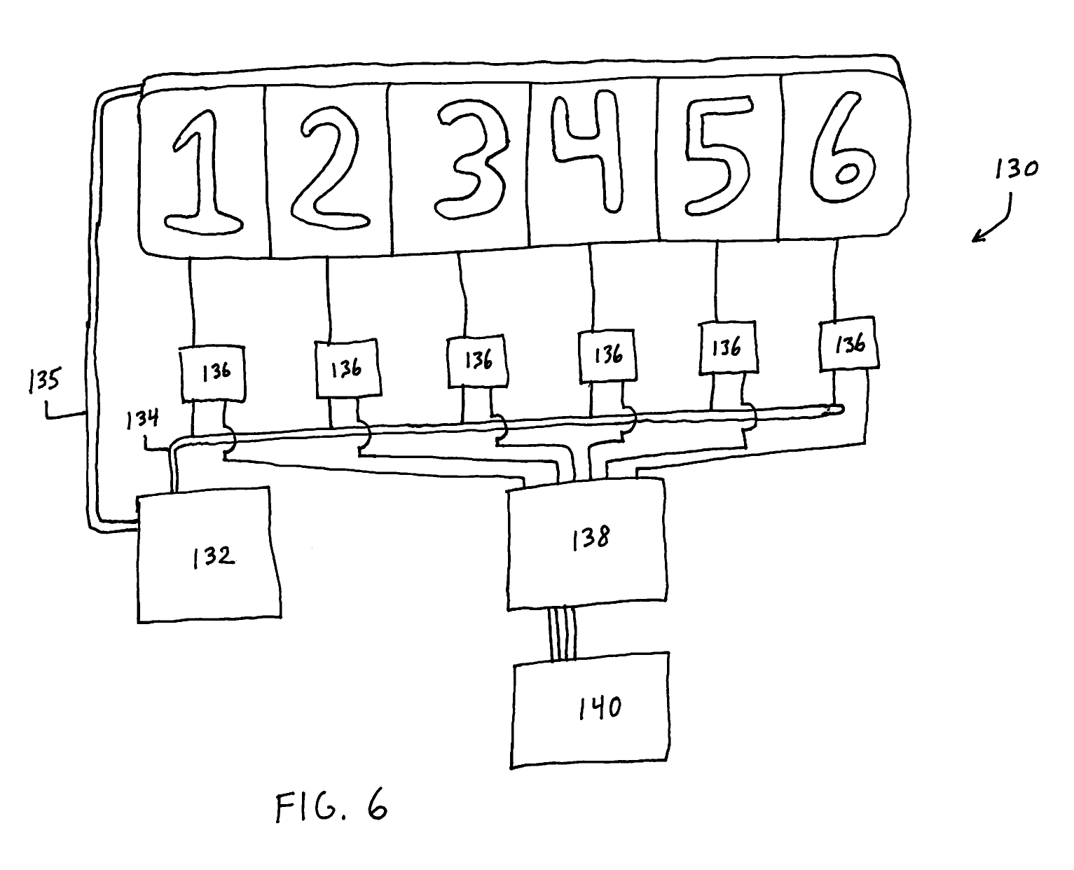

Now referring to FIG. 6, a schematic of a circuit 130 for driving individual EL displays is shown. A high-voltage oscillator 132 provides power on a bus 134 to individual SCRs 136. Electrical power is returned to the high-voltage oscillator through a second bus 135. Each SCR 136 drives an individual electroluminescent display (numbered one through six). A gate control circuit 138 receives a sequence of commands from a controller 140, so that the gate control circuit 138 selectively provides an individual gate voltage to each SCR. In this manner the controller 140 determines when each electroluminescent display will be illuminated. It is understood by those in the art that the number and its background may be driven by separate circuits. This allows for flashing of the number over its background and creates a visually attractive image. In FIG. 6, we have only provided one SCR per display element.

MIC4832 Electroluminescent Lamp Driver IC

There are other possible implementations which don't rely on the SCRs and other support circuitry, but instead drive the EL display segments from a single IC. For example, the MIC4832 is a self-contained 220 V_{PP} (volts peak to peak) electroluminescent lamp (EL) driver made by Micrel Inc. Providing custom sequencing or responding to data sent over the USB cable would still require additional hardware, however.

It should be noted that although a USB interface is being employed in the preferred embodiment, it is not a critical element of the invention. Other interfaces may be used such as 1394 (Firewire), RS232 or SCSI. It is a well known fact that computer interfaces are constantly changing to meet the ever increasing requirements for data throughput and power consumption. However, one of the design requirements of the Vidlids apparatus is to incorporate the current desktop/laptop interface standard. This feature will facilitate easy integration of Vidlids both as an accessory or as an integrated device (OEM) into the laptop/desktop.

Although the FIGS. 2, 3 illustrate Vidlids as an accessory for laptops, the invention is fully capable and designed to be integrated at the laptop manufacturer's assembly plant so that it is an integral component of the laptop at the time of retail sale to the consumer. The consumer will be able to configure Vidlids during his purchasing process over the web by selecting various EL panels, colors, shapes, and illumination sequences.

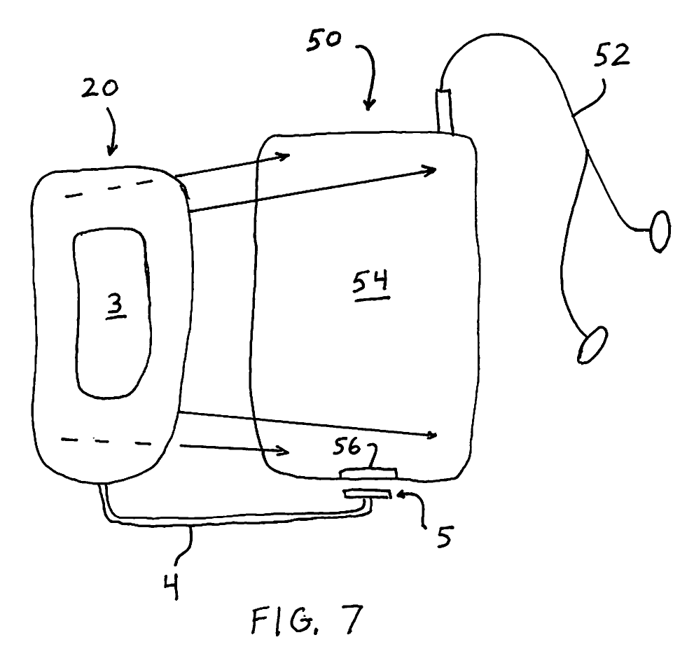

Now referring to FIG. 7, a fourth embodiment of the invention is shown. An exploded view similar to FIGS. 1-3 shows the rear view of an MP3 or other music player 50 with a headset 52 about to receive an EL assembly 20 onto the rear surface 54 of the music player 50. The assembly 20 will be held in place by a mild reusable adhesive. The EL assembly 20 has a cable 4 and connector 5 for mating with an electrical port 56 of the music player 50. Once the cable 4 is connected to the player 50, electrical power from the player 50 will drive the EL display 3. The display 3 may be controlled in the same manner as in the above embodiments. This embodiment may also be applied to other portable and or hand-held devices such as cell phones, walkie talkies, pagers, remote controls, electronic email or internet devices, electronic book readers, or miniature computers. In essence this accessory invention may be applied and attached to any device having a sharable source of electrical power and a surface area on which to attach the EL assembly 20. The EL assembly's 20 can be manufactured in varying sizes and shapes to accommodate any known or foreseeable host device.

While the present invention has been illustrated and described with reference to exemplary embodiments thereof, various modifications will be apparent to and might readily be made by those skilled in the art without departing from the scope and spirit of the present invention. Accordingly, it is not intended that the scope of the claims appended hereto be limited to the description as set forth herein, but, rather, that the claims be broadly construed.

We claim:

1. An electroluminescent display adaptable for use on the non-display side of a laptop computer top cover comprising:
an electroluminescent display panel having a viewing surface on a first side and an attaching surface on the opposite side;
a communication cable for electrically interfacing with the laptop computer to receive power and control signals;
whereby said cable receives power and control signals from the laptop computer and causes the electroluminescent display to operate in a predetermined manner so that a visual display pattern is presented to viewers in the sight line of the rear of the laptop top cover.

2. An electroluminescent display as claimed in claim 1 and further comprising:
a first cover for mounting on the laptop non-display side having a cutout for receiving the electroluminescent display, and having a cable cutout for routing the power/control cable from the EL display to an external USB port on the laptop;
a second cover for sandwiching the EL display between said covers;
said second cover having a slightly smaller cutout for allowing visual access to the EL display when assembled onto the laptop cover.

3. An electroluminescent display integrally assembled during a laptop build process for use on the non-display side of a laptop computer top cover comprising:
an electroluminescent display panel having a viewing surface on a first side and an attaching surface on the opposite side;
a communication cable for electrically interfacing with the laptop computer to receive power and control signals;
said communication cable connected to an internal laptop controller;
whereby said cable receives power and control signals from said controller and causes the electroluminescent display to operate in a predetermined manner so that a visual display pattern is presented to viewers in the sight line of the rear of the laptop top cover.
